(19) United States
(12) Patent Application Publication
(10) Pub. No.: US 2002/0152655 A1
(43) Pub. Date: Oct. 24, 2002

(54) Systems and techniques for simulating flames

(76) Inventors: David Allen Merrill, Mt. Vernon, IA (US); Edward Philip Lapointe, Mt. Vernon, IA (US)

Correspondence Address: Attn: Craig A. Gelfound, Esq., OPPENHEIMER WOLFF & DONNELY LLP, Suite 3800, 2029 Century Park East, Los Angeles, CA, 90067, US

(21) Appl. No.: 10/098,249

(22) Filed: Mar. 14, 2002

Related U.S. Application Data
(60) Provisional application No. 60/276,168, filed on Mar. 15, 2001.

(51) Int. Cl. G09F 19/00

(52) U.S. Cl. 40/428

(57) ABSTRACT

An apparatus includes a support member, a flame strip coupled to the support member, and an air source aimed at the flame strip. It is emphasized tat this abstract is provided to comply with the rules requiring an abstract which will allow a searcher or other reader to quickly ascertain the subject matter of the technical disclosure. It is submitted with the understanding that it will not be used to interpret or limit the scope or the meaning of the claims.

### CROSS-REFERENCE TO RELATED APPLICATIONS

The present application claims priority under 35 U.S.C. §119 (e) to provisional Application No. 60/276,168, filed Mar. 15, 2001.

### BACKGROUND

1. Field

The present invention relates generally to systems and techniques for simulating flames, and more specifically, to flame simulation in electric hearth products such as fireplaces, stoves, inserts, logsets and other similar appliances.

2. Background

The ambiance and warmth of fireplaces is highly desirable among consumers. Unfortunately, the expense and maintenance of traditional wood or gas-burning appliances often tend to reduce the market for such products. Some consumers may live in rental housing, and therefore, are prohibited from installing a traditional fireplace. Others consumers may already have an existing fireplace, but are tired of the debris left from burning wood, so they never use the fireplace. In addition, many consumers are concerned about having a source of combustion in their homes due to the negative effect these appliances may have on indoor air quality.

An electric appliance that simulates a wood or gas burning fire is an attractive solution to the traditional fireplace. These appliances can be installed in the home and simply plugged into the wall outlet. They are convenient and simple to use, and can be easily relocated to a different room or dwelling. However, the quality of the simulated flame is typically poor. Accordingly, there is a need for a technique which simulates a more realistic flame.

### SUMMARY

In one aspect of the present invention, an apparatus includes a support member, a flame strip coupled to the support member, an air source aimed at the flame strip, and at least one log arranged with the flame strip to simulate a log burning fire.

In another aspect of the present invention, an apparatus includes a non-circular support member, a flame strip coupled to the support member, and an air source aimed at the flame strip.

It is understood that other aspects of the present invention will become readily apparent to those skilled in the art from the following detailed description, wherein is shown and described only exemplary embodiments of the invention, simply by way of illustration. As will be realized, the invention is capable of other and different embodiments, and its several details are capable of modifications in various respects, all without departing from the invention. Accordingly, the drawings and description are to be regarded as illustrative in nature, and not as restrictive.

### BRIEF DESCRIPTION OF THE DRAWINGS

Aspects of the present invention are illustrated by way of example, and not by way of limitation, in the accompanying drawings in which like reference numerals refer to similar elements wherein:

FIG. 1 is a cross-section view of an exemplary appliance for simulating wood or gas burning flames;

FIG. 2 is a cross-section view of an exemplary flame strip for use in an appliance which simulates wood or gas burning flames;

FIG. 3 is a perspective front view of an exemplary appliance for simulating wood or gas burning flames; and

FIG. 4 is a perspective rear view of an exemplary appliance for simulating wood or gas burning flames.

### DETAILED DESCRIPTION

The detailed description set forth below in connection with the appended drawings is intended as a description of exemplary embodiments of the present invention and is not intended to represent the only embodiments in which the invention can be practiced. The term “exemplary” used throughout this description means “serving as an example, instance, or illustration,” and should not necessarily be construed as preferred or advantageous over other embodiments. The detailed description sets forth the inventive concepts in terms of construction and function of exemplary appliances for simulating wood or gas burning flames. It is to be understood, however, that the same, equivalent, and alternative constructions and functions may be accomplished with other appliances which are also intended to be encompassed within the spirit and scope of the invention.

In an exemplary appliance, flame-shape strips made from a reflective material may be used. The flame strip may include a base which can be positioned above an air source. A multi-piece set of logs may be arranged around the air outlet and flame strip base, and can be supported by a grate structure. An artificial ember bed may also be included below the grate. A light source may be used to illuminate the flame strip. The light source may be located in various locations within the appliance. By way of example, the light source can be disposed within the front log hidden from the view of the consumer. All of these components may be electrically connected together and terminated with a power cord that can be plugged into a normal household current supply.

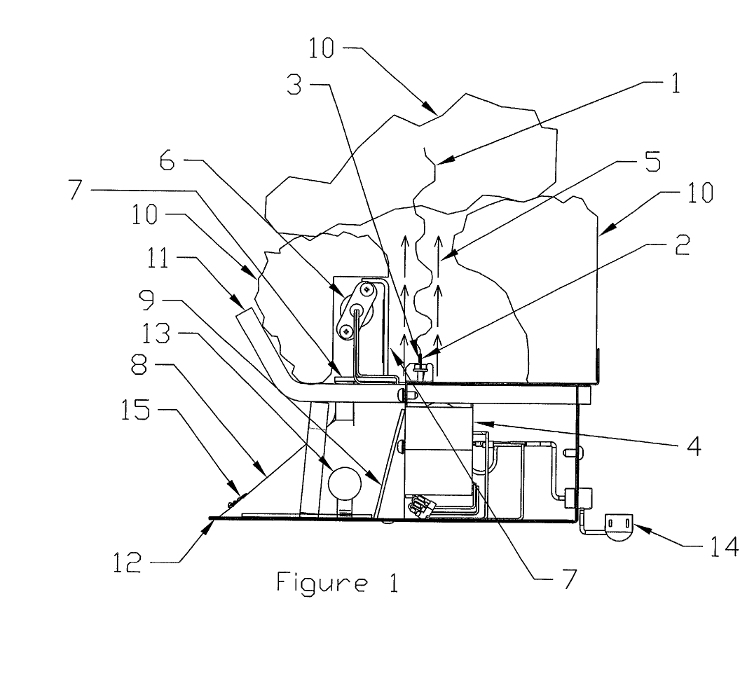

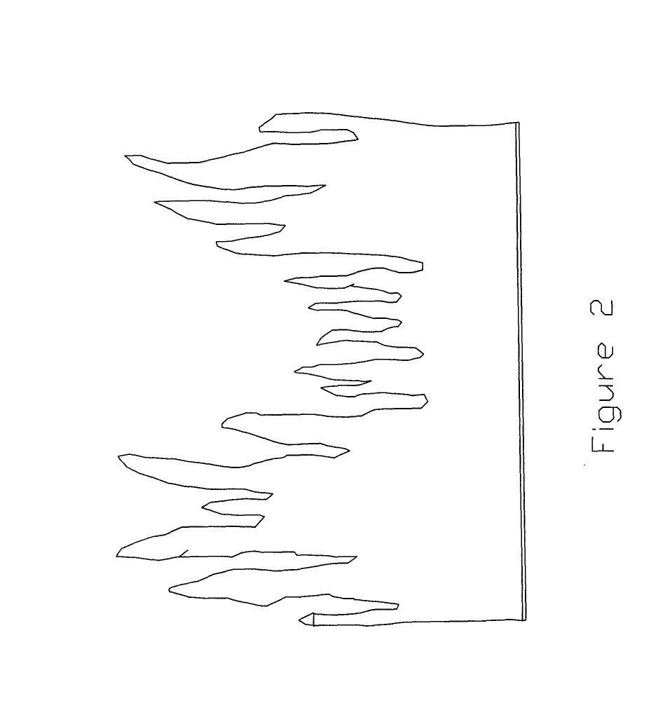

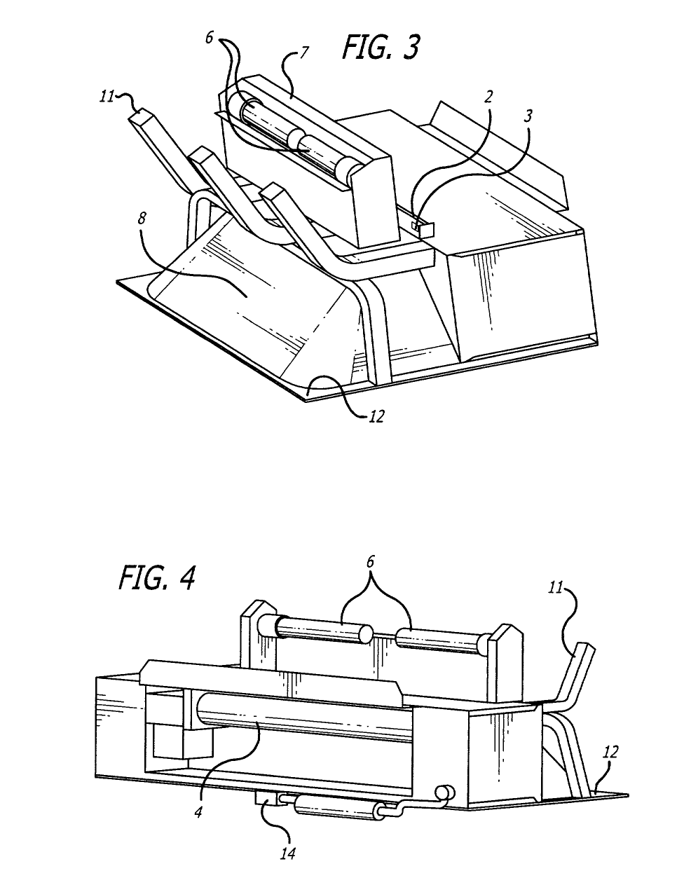

FIGS. 1, 3 and 4 show an exemplary appliance with a simulated flame. A flame strip 1 can be made from reflective or a partially reflective material, including but not limited to, metallized film, cellophane, cloth, Mylar, or and other similar material. This material can be cut into finger-like tongues extending from a base to represent tongues of the flame strip as shown in FIG. 2. The flame strips 1 may be made as a single layer of material, may be laminated into multiple layers, or may be sewed or similarly formed into a “wind sock” type of shape to enhance the movement of the flame strip. The materials may be cut, shaped, sewed, and slitted, etc., to give desired characteristics. The flame strip 1 may also be printed with colors or markings to further enhance their appearance. In addition, the flame strips 1 can be made from different materials used together in different layers or fastened together by any method to create a more realistic effect. Other methods could be used to soften the sharpness of the edges, like small cuts, oiled edges, different colored materials next to each other, or colored edges, etc.

The base of the flame strip 1 can be fixed to a support bar 2 by means of magnets 3, adhesives, or any other mechanical fasteners. Alternately, the base of the flame strip 1 may be wrapped around a rod with the ends of the base fixed to itself at a point just above the rod so the flame strips 1 can pivot freely about the rod. An exemplary appliance may include of one or more of these rods, and the flame strip 1 may be placed at various elevations within the appliance to achieve differing flame heights. At the top end, the fire strip 1 can be left free and unsupported.

The support bar 2 or rod to which the base of the flame strips is attached can be positioned above a source of upward-moving air. This source of air may be a blower 4 or fan that impels air directly onto the flame strip 1, or the air may come from an opening in a box that is pressurized by a blower or fan. In some applications, the airflow may be due to upwardly moving natural convection airflow. The upward moving air stream 5 forces the flame strip 1 to rise up and stand in a vertical position and gives a rippling effect to the simulated flames. Speed controls or other mechanical devices may be used to change the speed at which the air stream moves thus changing the oscillation of the flame strip 1. Such devices are well known in the art.

A light source 6 may be used in conjunction with the rippling flame strip 1. The light source 6 may be an incandescent, florescent, halogen, or similar light source attached to the appliance and positioned so that its directs light onto the rippling flame strip 1. Alternately, the light source 6 may be independent of the appliance and placed so that it directs or reflects its light onto the rippling flame strip 1. Mirrors or other reflective elements may be used to redirect the light from the light source 6. Controls to vary the intensity of the light source 6 or cause blinking or flickering may be used to give different characteristics to the light. Such controls or devices are well known in the art.

The color of the light source 6 may be altered to create a particular effect. The light bulb may be colored, or one or more colored lenses 7 may be placed in the path of the light so the color of the rippling flames strip 1 is affected. The lens 7 may be made of transparent or translucent material, such as glass, plastic, or cellophane, and may be tinted to a particular color or may have a colored film or coating applied to it. To create a realistic flame effect, the color of the light bulb or lens should be predominately red, orange and/or yellow. However, to produce other effects, or to match the color scheme of a particular room, any color light bulb or lens may be used. A lens may also be multi-colored or employ a means to continually change the color. Multiple lenses may be used to vary the illumination inside the appliance.

An artificial ember bed 8 may also be used in conjunction with the flame strip 1. A second light source 13 placed behind the ember bed 18 can be used to illuminate the artificial ember bed 8 from within. The light source 13 can be an incandescent, florescent, halogen or similar light source. This light source 13 can be fitted with an electronic device that allows the light to periodically or randomly get brighter or darker creating the effects that the embers are real. Alternatively, multiple light sources may be used with each light bulb independently driven by such a device. These light sources may employ lenses to achieve desired colors. Mirrors 9 may be used to reflect light generated by the light source 13 through the artificial ember bed 8.

The artificial ember bed 8 may be made of many translucent and/or transparent materials or a transparent and/or translucent material that is embedded with pieces of colored glass or plastic. The shape of the artificial ember bed 8 can generally be that of a pile of ashes and coals that has built up under a fireplace grate, and may be made by vacuum forming, molding, casting, etc. Surface texture of the artificial ember bed 8 may be rough or bumpy to replicate the surface of a real ember bed. The artificial ember bed 8 may be colored to resemble glowing embers, or the surface may also be coated with materials or media 15 that cause the ember look. Some materials will look ember-like when illuminated and ashen like with no illumination so that many combinations are possible to achieve the desired result. These materials or media can be transparent, translucent, opaque, or any combination, and may be spread out or sprinkled on and/or around the artificial ember bed 8 to give the look of ashes or coals on the floor of the appliance.

Imitation logs 10, imitation coals, real logs, real coals, or any combination thereof (referred to collectively or individually as “logs”) may be used with the flame strip 1 and artificial ember bed 8. The logs 10 may be a multiple piece set that simulates a pile of wood. A grate structure 11 may be used to support the logs 10. The logs 10 may be pieces of real wood or artificial logs made of foam, concrete, ceramic fiber, or other material. The logs 10 may be used to add realism and conceal various components of the appliance when power is removed. The shape and position of the logs 10 can be utilized to control the upward airflow stream 5, and therefore, control the performance of the flame strip 1. The shape and position can also be used to conceal the light source 6 and to enhance and control the shadows that are produced by the flame strip 1. In addition, multiple sets and or combinations of logs can be provided so that the consumer can alter the appearance of the appliance periodically.

All the components may be assembled onto a baseplate structure 12, either directly or indirectly by being connected to another part that eventually connects to the baseplate. The components can be electrically connected and terminated with a conventional plug 14 for ease of installation. The flame strip 1 in combination with the artificial ember bed 8 may be used independent of the appliance to replicate a bonfire, campfire, or other freestanding fire. The flame strip 1 and artificial ember bed may be attached to a base and used as a log set to be placed in an existing fireplace, wood stove, or placed in an alcove, structure or appliance to replicate a wood-burning appliance in a typical home. The flame strip 1 and artificial ember bed 8 may be integrated into a fireplace, freestanding stove, fireplace insert, or other type of hearth product.

In operation, the flame strip 1 rises into a vertical position and flutters in the supporting airflow. Each dancing tongue of the flame strip appears to be a moving, bright flame. The fluttering motion gives a three dimensional movement and appearance to the flame, and depending on the material used, may also give a rustling sound that simulates the snaps and pops of a real burning fire. Light shining towards the flame strip casts shadows onto the rear wall of the fireplace as it passes through the moving flame strip. The light reflected by the flame strip cast similar shadows and reflections on the sides of the fireplace. Below the grate the light reflected through the ember bed gives the impression of glowing coals. When power is removed, the airflow stops and the lights go off. The flame strip 1 that had been held in a vertical position by the airflow now simply falls down and curls up in between the logs and are out of view of the consumer.

Although exemplary embodiments of the present invention have been described, they should not be construed to limit the scope of the appended claims. Those skilled in the art will understand that various modifications may be made to the described embodiments. It is therefore desired that the described exemplary embodiments be considered in all aspects as illustrative and not restrictive, reference being made to the appended claims rather than the foregoing description to indicate the scope of the invention.

What is claimed is:

1. An apparatus, comprising:
a support member;
a flame strip coupled to the support member;
an air source aimed at the flame strip; and
at least one log arranged with the flame strip to simulate a log burning fire.

2. The apparatus of claim 1 wherein the flame strip comprises a reflective material.

3. The apparatus of claim 2 further comprising a light source aimed at the reflective flame strip.

4. The apparatus of claim 1 further comprising a magnet coupling the flame strip to the support member.

5. The apparatus of claim 1 further comprising a light source aimed at the flame strip.

6. The apparatus of claim 5 where in the light source is disposed within the log.

7. The apparatus of claim 1 further comprising a grate supporting the log.

8. The apparatus of claim 1 further comprising an artificial ember bed positioned beneath the log.

9. The apparatus of claim 8 further comprising a second light source aimed at the artificial ember bed.

10. The apparatus of claim 1 wherein the air source is aimed at the flame strip to cause an air stream along opposing sides of the flame strip.

11. An apparatus, comprising:
a non-circular support member;
a flame strip coupled to the support member; and
an air source aimed at the flame strip; and

12. The apparatus of claim 11 further comprising at least one log arranged with the flame strip to simulate a log burning fire.

13. The apparatus of claim 12 further comprising a light source disposed within the log and aimed at the flame strip.

14. The apparatus of claim 11 wherein the flame strip comprises a reflective material.

15. The apparatus of claim 11 further comprising a magnet coupling the flame strip to the support member.

16. The apparatus of claim 11 further comprising a light source aimed at the flame strip.

17. The apparatus of claim 11 further comprising a grate supporting the log.

18. The apparatus of claim 11 further comprising an artificial ember bed positioned beneath the log.

19. The apparatus of claim 18 further comprising a second light source aimed at the artificial ember bed.

20. The apparatus of claim 11 wherein the air source is aimed at the flame strip to cause an air stream along opposing sides of the flame strip.
